(19) United States
(12) Patent Application Publication
(10) Pub. No.: US 2016/0381345 A1
(43) Pub. Date: Dec. 29, 2016

(54) STEREOSCOPIC CAMERA DEVICE AND ASSOCIATED CONTROL METHOD

(71) Applicant: MediaTek Inc., Hsin-Chu (TW)

(72) Inventors: Yi-Ruei WU, Tainan City (TW); Cheng-Che CHAN, Zhubei City (TW); Po-Hao HUANG, Kaohsiung City (TW)

(21) Appl. No.: 14/957,973

(22) Filed: Dec. 3, 2015

Related U.S. Application Data
(60) Provisional application No. 62/186,137, filed on Jun. 29, 2015.

(51) Int. Cl. H04N 13/02; H04N 5/235; G06T 7/00; G06T 5/00; G06T 7/20; H04N 5/232; H04N 5/341

(52) U.S. Cl. CPC H04N 13/0239; H04N 13/0246; H04N 13/0296; H04N 5/23212; H04N 5/2355; H04N 5/3415; G06T 5/007; G06T 5/002; G06T 7/2046; G06T 7/2093; G06T 7/0069; G06T 2207/10021; G06T 2210/52; G06T 2207/10028; H04N 2013/0088

(57) ABSTRACT

A stereoscopic camera device and an associated control method are provided. The stereoscopic camera device includes: a first image capturing device, a second image capturing device, and a processor. The first image capturing device is configured to capture a first image with a first field of view along a first optical axis. The second image capturing device is configured to capture a second image with a second field of view along a second optical axis simultaneously with the first image capturing device, wherein the first field of view and the second field of view are overlapped. The processor is configured to dynamically adjust the overlapping of the first field of view and the second field of view according to an operational mode of the stereoscopic camera device.

### CROSS REFERENCE TO RELATED APPLICATIONS

This application claims the benefit of U.S. Provisional Application No. 62/186,137, filed on Jun. 29, 2015, the entirety of which is incorporated by reference herein.

### BACKGROUND OF THE INVENTION

Field of the Invention

The invention relates to a camera device, and, in particular, to a stereoscopic camera device and an associated control method capable of dynamically adjusting an overlapping region of field of views of a plurality of image capturing devices

Description of the Related Art

With recent advancements made in technology, electronic devices deployed with stereoscopic camera devices have become widely used nowadays. However, a conventional stereoscopic camera device in an electronic device on the market can only be used to capture images with a fixed camera arrangement, resulting in less flexibility and higher complexity to generate images for different applications. Accordingly, there is a demand for a stereoscopic camera device and an associated control method to solve the aforementioned issue.

### BRIEF SUMMARY OF THE INVENTION

A detailed description is given in the following embodiments with reference to the accompanying drawings.

In an exemplary embodiment, a stereoscopic camera device is provided. The stereoscopic camera device includes: a first image capturing device, a second image capturing device, and a processor. The first image capturing device is configured to capture a first image with a first field of view along a first optical axis. The second image capturing device is configured to capture a second image with a second field of view along a second optical axis simultaneously with the first image capturing device, wherein the first field of view and the second field of view are overlapped. The processor is configured to dynamically adjust the overlapping of the first field of view and the second field of view. The processor can perform the adjustment according to an operational mode of the stereoscopic camera device.

In another exemplary embodiment, a control method for a stereoscopic camera device is provided. The stereoscopic camera device comprises a first image capturing device and a second image capturing device. The method includes the steps of: utilizing the first image capturing device to capture a first image with a first field of view along a first optical axis; utilizing the second image capturing device to capture a second image with a second field of view along a second optical axis simultaneously with the first image capturing device, wherein the first field of view and the second field of view are overlapped; and dynamically adjusting the overlapping of the first field of view and the second field of view according to an operational mode of the stereoscopic camera device.

### BRIEF DESCRIPTION OF THE DRAWINGS

The invention can be more fully understood by reading the subsequent detailed description and examples with references made to the accompanying drawings, wherein:

FIG. 1 is a diagram of a stereoscopic camera device in accordance with an embodiment of the invention;

FIGS. 2A-2C are diagrams of different operational modes of the stereoscopic camera device in accordance with an embodiment of the invention;

FIG. 2D-2F are diagrams of the overlapped region between the FOVs of the first image capturing device and the second image capturing device in accordance with an embodiment of the invention;

FIGS. 3A-3C are diagrams of rotation by the optical axis in different operational modes of the stereoscopic camera device in accordance with an embodiment of the invention;

FIGS. 4A-4B are diagrams of different operation modes of the stereoscopic camera device in accordance with another embodiment of the invention;

FIGS. 5A-5D are diagrams illustrating different implementations to change optical axes of a first image capturing device and a second image capturing device in accordance with an embodiment of the invention;

FIG. 6A is a block diagram of rotation control of a first image capturing device and a second image capturing device in accordance with an embodiment of the invention;

FIG. 6B is a flow chart of the rotation control method in accordance with an embodiment of the invention; and

FIG. 7 is a flow chart of a control method for the stereoscopic camera device in accordance with an embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

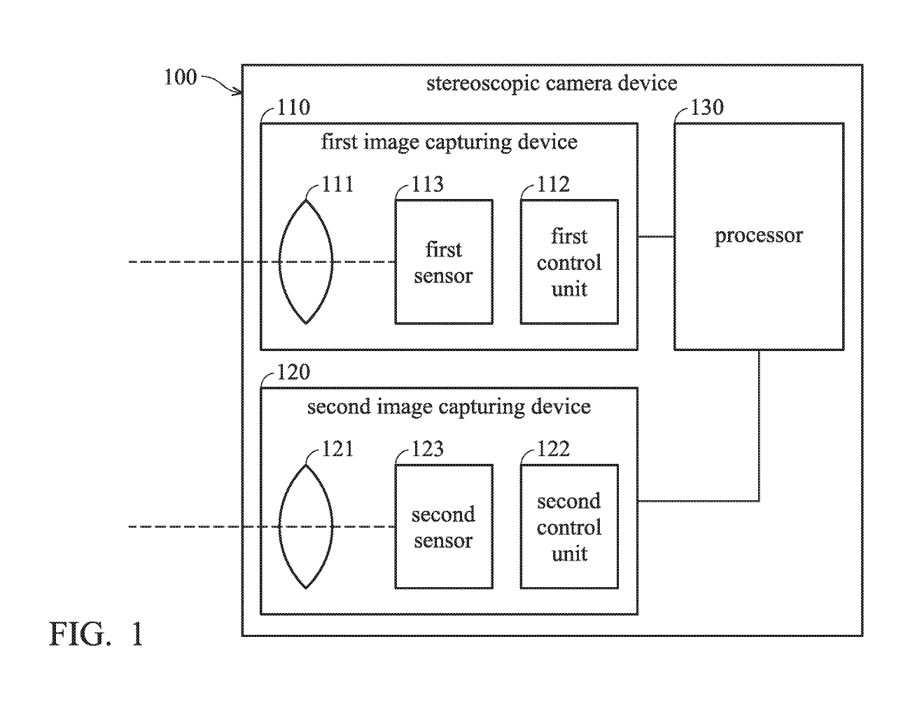

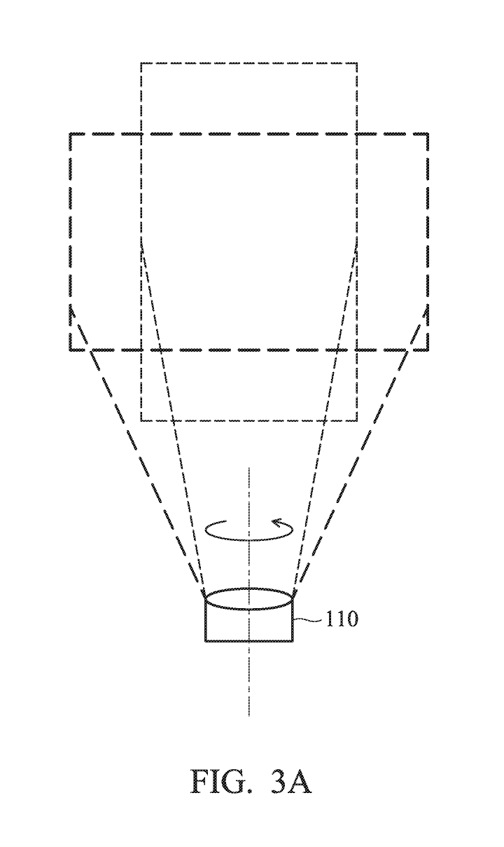

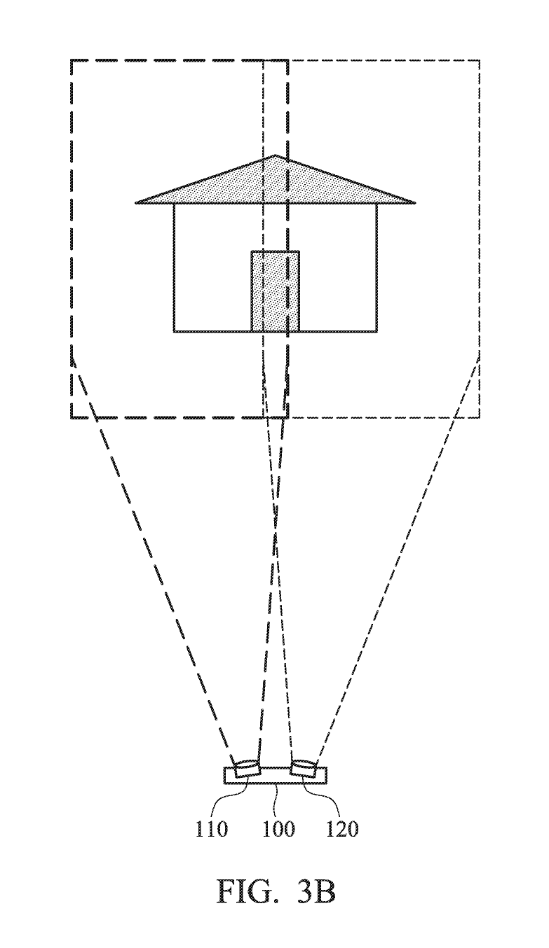

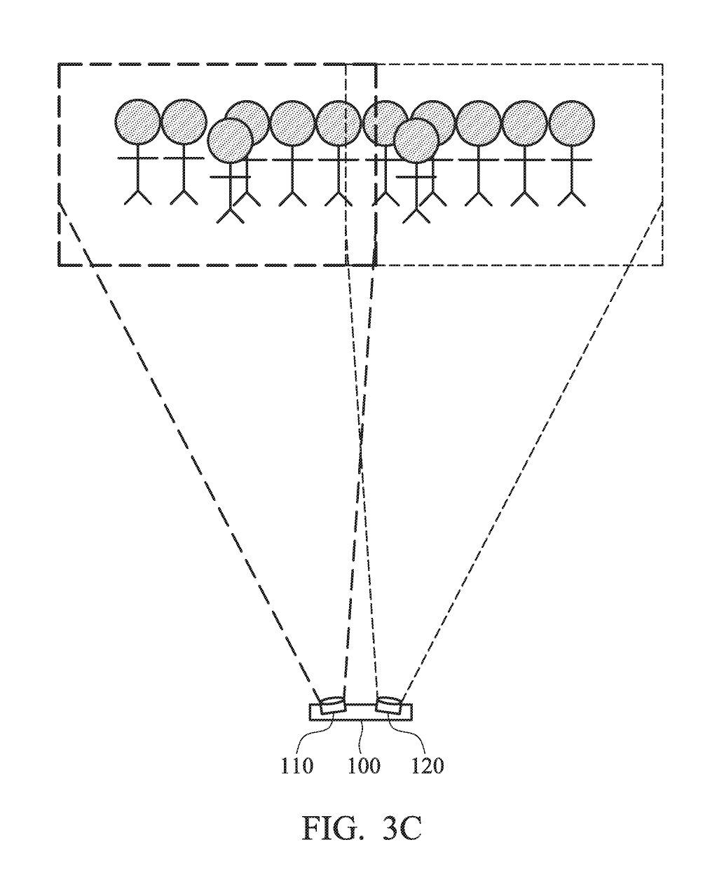

FIG. 1 is a diagram of a stereoscopic camera device in accordance with an embodiment of the invention. The stereoscopic camera device may be a digital camera module that can be integrated into a consumer electronic device or into any other electronic component or device in which digital camera functionality may be embedded, including professional digital video and still cameras. The stereoscopic camera device 100 comprises a plurality of image capturing device, which for example, can include a first image capturing device 110 and a second image capturing device 120. In addition, and the stereoscopic camera device 100 can include a processor 130. Each of the first image capturing device 110 and the second image capturing device 120 may include one or more respective lenses and one or more respective sensors to detect and covert light. The image capturing device can also include a digital camera, film camera, digital sensor, charge-coupled device or other image-capturing device. The first image capturing device 110 and the second image capturing devices 110 and 120 are configured to capture images at different view angles. Specifically, the first image capturing device 110 is configured to capture a first image with a first field of view (FOV) along a first optical axis, and the second image capturing device 110 is configured to capture a second image with a second field of view along a second optical axis. The capturing operation of the first capturing image device 110 and the second image capturing device 110 can be performed simultaneously or synchronously with each other, and the first FOV and the second FOV can be overlapped. In an embodiment, the first image capturing device 110 and the second image capturing device 120 may be a left camera and a right camera, and the first image and the second image may be a left-eye image and a right-eye image, respectively. In another embodiment, the first image capturing device 110 and the second image capturing device 120 may be a bottom camera and a top camera, and the first image and the second image may be a bottom-view image and a top-view image, respectively. The processor 130 is configured to dynamically adjust the overlapping of the first field of view and the second field of view. The processor 130 can dynamically perform the adjustment according to an operational mode of the stereoscopic camera device 100, and the details will be described in the embodiments of FIGS. 3A-3C.

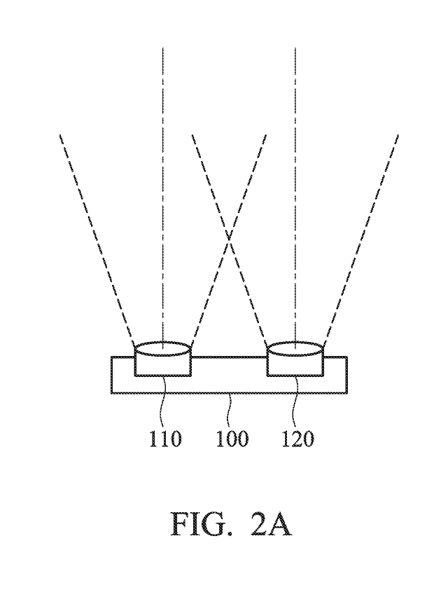

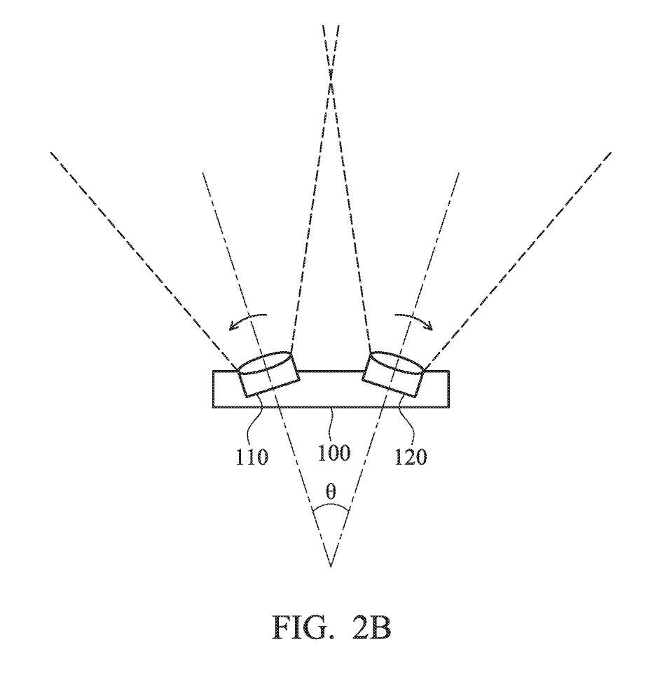

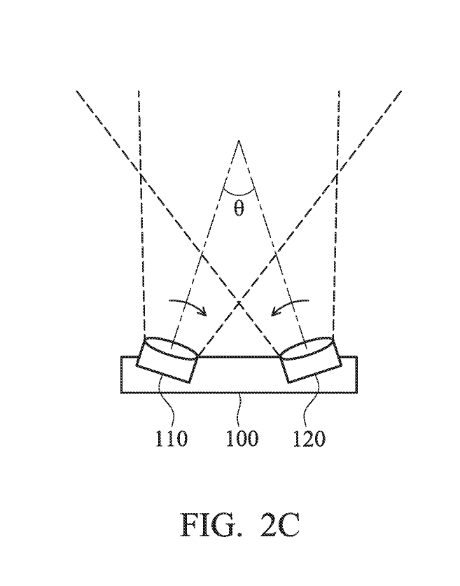

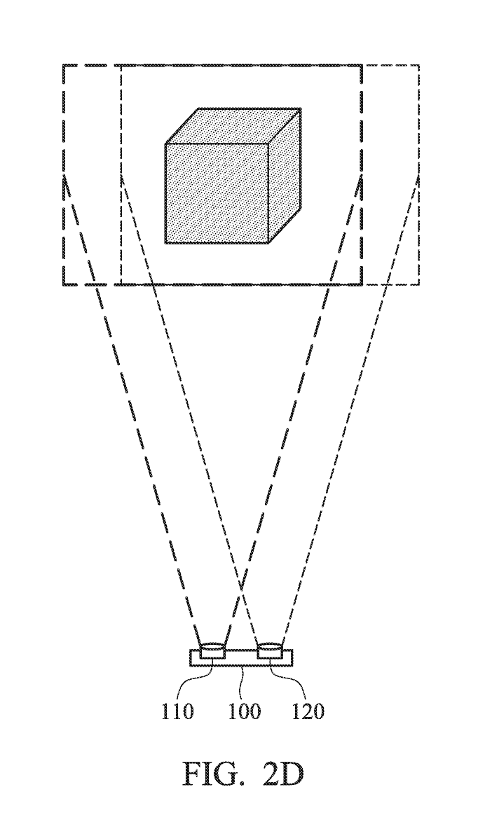

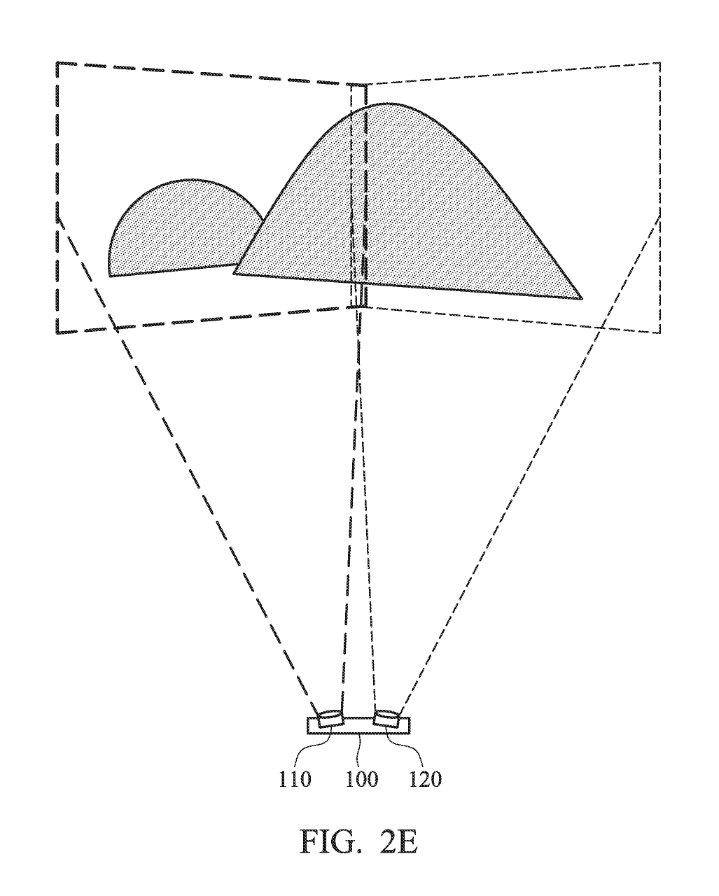

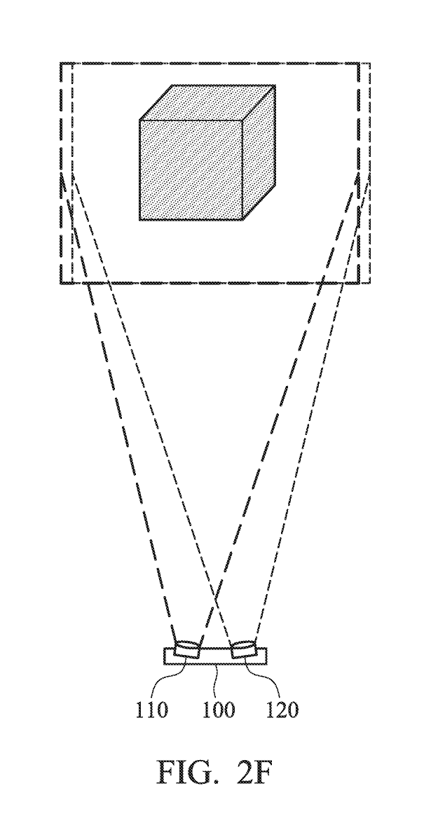

FIGS. 2A-2C are diagrams of different operational modes of the stereoscopic camera device in accordance with an embodiment of the invention. For example, there are several operational modes of the stereoscopic camera device 100 such as a parallel mode, a divergence mode, and a convergence mode, as shown in FIG. 2A, FIG. 2B, and FIG. 2C, respectively. In different operational modes of the stereoscopic camera device 100, the first optical axis of the first image capturing device 110 and the second optical axis of the second image capturing device 120 cross at different locations or do not cross at any location. More specifically, in the parallel mode, the first optical axis of the first image capturing device 110 and the second optical axis of the second image capturing device 120 are parallel to each other, and thus these two optical axes does not cross at any location, as shown in FIG. 2A. In the divergence mode, the first optical axis of the first camera 110 and the second optical axis of the second camera 120 cross each other at the back of the first image capturing device 110 and second image capturing device 120, as shown in FIG. 2B. In the convergence mode, the first optical axis of the first camera 110 and the second optical axis of the second camera 120 cross each other in front of the first and second image capturing devices, as shown in FIG. 2C. As clearly shown in FIGS. 2A, 2B and 2C, along with different crossing conditions of the optical axes, the overlapping of the first field of view and the second field of view are also different.

Referring to FIG. 1 and FIGS. 2A-2C, the first image capturing device 110 comprises a first lens 111, a first control unit 112, and a first image sensor 113, and the second image capturing device 120 comprises a second lens 121, a second control unit 122, and a second image sensor 123. It should be noted that the first lens 111 and the second lens 121 may comprise one or more lens in different embodiments. The processor 130 may dynamically adjust the overlapping of the first FOV and the second FOV by rotating at least one of the first image capturing device 110 and the second image capturing device 120. For example, the first control unit 112, which can include either or both of mechanical hardware and associated software controlling module, may control the first image capturing device 110 to rotate the first optical axis on a plane of the first optical axis, or rotate the first image capturing device 110 around an extension direction of the first optical axis (e.g. rotation about a center of the first image capturing device 110). The second control unit 122 may control the second image capturing device 120 to rotate the second optical axis on a plane of the second optical axis. Moreover, when the rotation of the first image capturing device 110 and the second image capturing device 120 are based on a plane of the first optical axis and a plane of the second optical axis respectively, the processor 130 may control an included angle θ between the first optical axis of the first image capturing device 110 and the second optical axis of the second image capturing device 120. Due to any of the rotating operations, the stereoscopic camera device 100 can be switched between different modes such as the parallel mode, the divergence mode, and the convergence mode as shown in FIGS. 2A˜2C.

FIGS. 2D˜2F are diagrams of the overlapped region between the FOVs of the first image capturing device and the second image capturing device in accordance with an embodiment of the invention. In an embodiment, the processor 130 may merge the first image captured by the first image capturing device 110 and the second image captured by the second image capturing device 120 to generate a third image covering a third FOV along a third optical axis. The third optical axis may be one of the first optical axis and the second optical axis. For example, when the stereoscopic camera device 100 operates in the parallel mode, the processor 130 merges the first image and the second image to generate a stereoscopic image as the third image, where the first image and the second image may be a left-eye image and a right-eye image, respectively, as shown in FIG. 2D. The processor 130 may calculate the depth information according to the first image and the second image (e.g. based on the parallax between the first image capturing device 110 and the second image capturing device 120), thereby generating the stereoscopic image.

When the stereoscopic camera device 100 operates in the divergence mode, the processor 130 may stitch the first image and second image to generate an output image, where the output image may be an ultra-wide angle image, a panorama image, or a sphere image. The overlapped region 220 between the first FOV and the second FOV in the divergence mode is smaller than the overlapped region 210 in the parallel mode, as shown in FIG. 2E.

When the stereoscopic camera device 100 operates in the convergence mode, the processor 130 may use the first image and the second image for generating an output image having higher image quality, or optimizing the depth information, as shown in FIG. 2F. The overlapped region 230 between the first FOV and the second FOV in the convergence mode is larger than the overlapped region 210 in the parallel mode. For example, in the convergence mode, the processor 130 further performs one or more of the following applications: obtaining a high dynamic range (HDR) image, noise reduction, and macro photography.

FIGS. 3A˜3C are diagrams of rotation by the optical axis in different operational modes of the stereoscopic camera device in accordance with an embodiment of the invention. Referring to FIG. 1 and FIG. 3A, the first control unit 112 may control the first image capturing device 110 to rotate around an extension direction of the first optical axis (e.g. rotation about the center of the first image capturing device 110), so that the first image capturing device 110 can be rotated by rotating the optical axis itself, and the captured first image can switched between a portrait mode and a landscape mode, as shown in FIG. 3A. Similarly, the second control unit 122 may control the second image capturing device 120 to rotate around an extension direction of the second optical axis (e.g. rotation about the center of the second image capturing device 120), so that the second image capturing device 120 can be rotated by rotating the optical axis itself, and the captured second image can switched between a portrait mode and a landscape mode. Specifically, the processor 130 may control either of both of the first image capturing device 110 and the second image capturing device 120 to rotate their respective optical axies to form the first image and the second image respectively having different aspect ratios.

As shown in FIG. 3B, the first image captured by the first image capturing device 110 and the second image captured by the second image capturing device 120 are both in the portrait mode, and the processor 130 combines the first image and the second image to generate a panorama image.

As shown in FIG. 3C, the first image captured by the first image capturing device 110 and the second image captured by the second image capturing device 120 are both in the landscape mode, and the processor 130 combines the first image and the second image to generate a ultra wide-angle image.

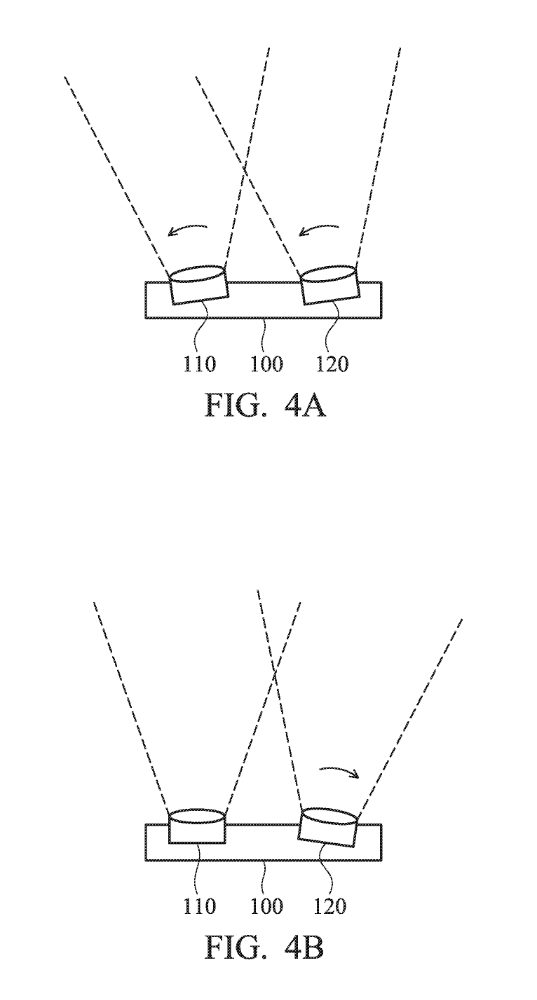

FIGS. 4A˜4B are diagrams of different operation modes of the stereoscopic camera device in accordance with another embodiment of the invention. The rotation control of the first image capturing device 110 and second image capturing device 120 can be performed in different manners. For example, when the stereoscopic camera device 100 operates in the parallel mode, the first optical axis of the first image capturing device 110 and the second optical axis of the second image capturing device 120 are parallel to each other, and are perpendicular to the surface on which the first image capturing device 110 and the second image capturing device 120 are deployed. In the parallel mode, the first image capturing device 110 and the second image capturing device 120 can be rotated synchronously to maintain the parallel relation therebetween. Specifically, the first optical axis of the first image capturing device 110 and the second optical axis of the second image capturing device 120 are kept parallel to each other, but are not perpendicular to the surface on which the first image capturing device 110 and the second image capturing device 120 are deployed, so that the first optical axis of the first image capturing device 110 and the second optical axis of the second image capturing device 120 are in the same direction, as shown in FIG. 4A.

In another embodiment, the rotation of the first image capturing device 110 and the second image capturing device 120 can be controlled freely and independently, and thus the first image capturing device 110 and the second image capturing device 120 may focus on different objects, as shown in FIG. 4B. Furthermore, when the processor 130 executes a tracking application, the processor 130 may control the first image capturing device 110 and the second image capturing device 120 to track a first moving object and a second moving object at the same time, respectively. The processor 130 may also stitch the first image and the second image to generate an output image, or keep the first image and the second individually for subsequent processing.

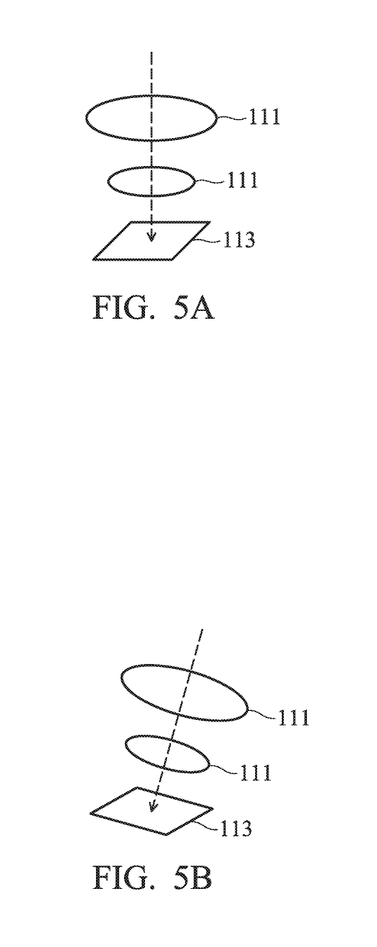

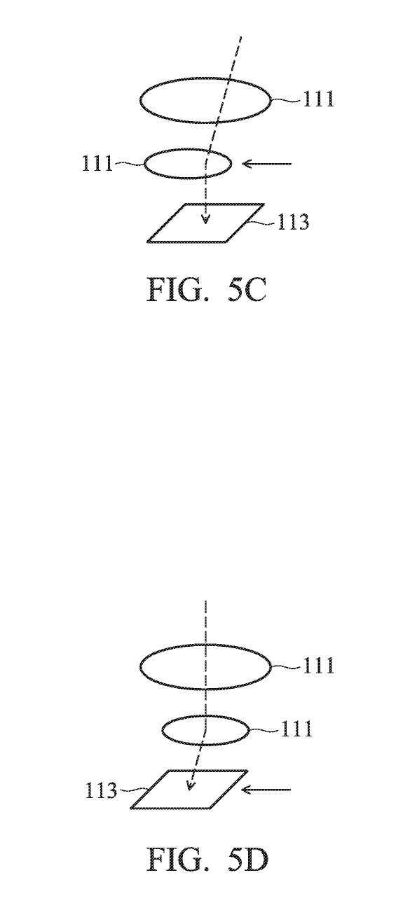

FIGS. 5A˜5D are diagrams illustrating different implementations to change the optical axes of the first image capturing device and the second image capturing device in accordance with an embodiment of the invention. For ease of description, the first optical axis of the first image capturing device 110 is used the embodiments in FIGS. 5A˜5D. One having ordinary skill in the art will appreciate the different implementations can be applied to the second image capturing device 120.

Referring to FIG. 5A, the first optical axis is perpendicular to the surfaces of the lenses of the first image capturing device 110 by default. There are several ways to change the first optical axis of the first image capturing device 110. For example, the whole module of the first image capturing device 110 is rotated, so that the first optical axis is also rotated accordingly, as shown in FIG. 5B. Alternatively, the first control unit 112 may skew the first optical axis by shifting all or a portion of the lenses. For example, one of the lenses is shifted, and the first optical axis is rotated accordingly, as shown in FIG. 5C. Alternatively, the first control unit 112 may also skew the first optical axis by shifting the first image sensor 123, as shown in FIG. 5D.

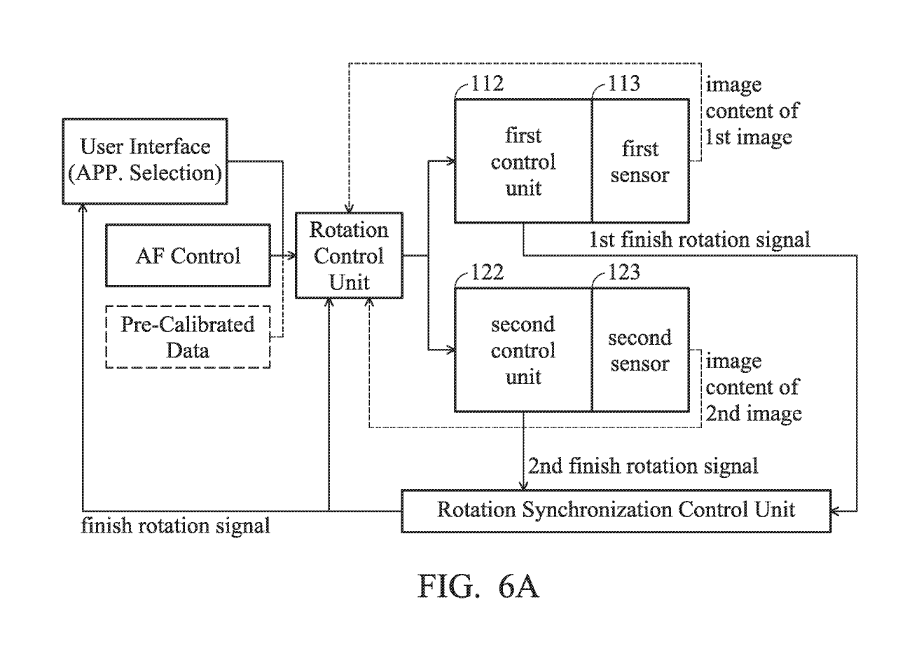

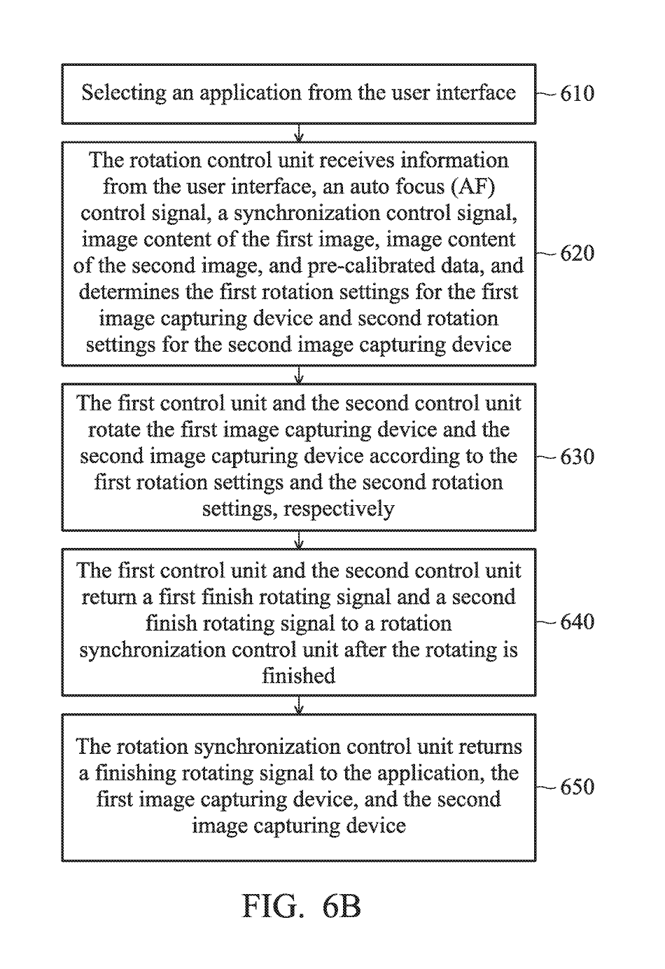

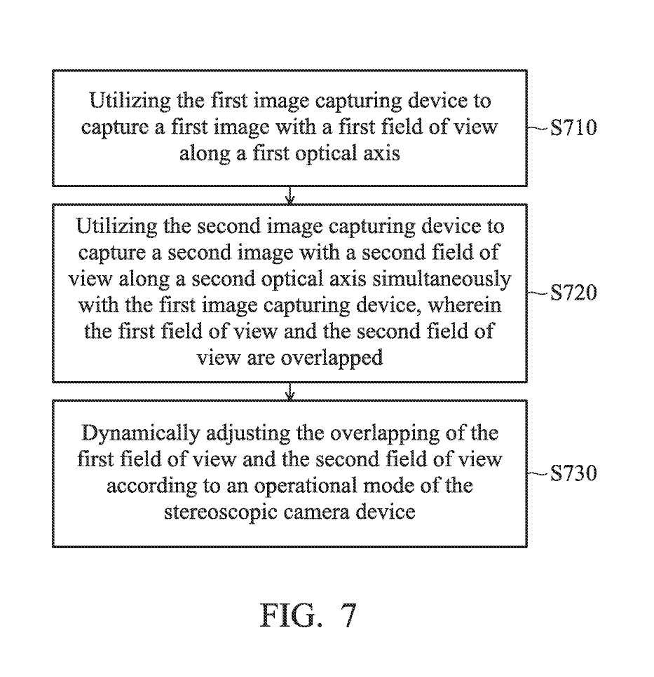

In the following section, details of the rotation control of the first image capturing device 110 and the second image capturing device 120 will be described. FIG. 6A is a block diagram of rotation control of the first image capturing device 110 and the second image capturing device 120 in accordance with an embodiment of the invention. FIG. 6B is a flow chart of the rotation control method in accordance with an embodiment of the invention. The method may include one or more operations, actions, or functions as represented by one or more steps such as steps S610-S650. Although illustrated as discrete steps, various steps of the method may be divided into additional steps, combined into fewer steps, or eliminated, depending on the desired implementation. The method may be implemented by the stereoscopic camera device 100 of FIG. 1 and the rotation control of FIG. 7 but is not limited thereto. Solely for illustrative purpose and without limiting the scope of the present disclosure, the method of FIG. 6B is described below in the context of method 6B being performed by the stereoscopic camera device 100 of FIG. 1 with the rotation control of FIG. 6A. The method may begin at 610.

In block 610, the user may select an application from the user interface. For example, the user may start an image capturing application or a video recording application. In block 620, the rotation control unit (e.g. the processor 130) receives information from the user interface, and one or more of the following signal/data: an auto focus (AF) control signal, a synchronization control signal, image content of the first image, image content of the second image, and pre-calibrated data, and determines the first rotation settings for the first image capturing device 110 and the second rotation settings for the second image capturing device 120. In other words, the processor 130 may dynamically adjust the overlapping of the first FOV and the second FOV according to one or more of an AF control signal, a synchronization control signal, image content of the first image, image content of the second image, and pre-calibrated data.

The AF control signal may be from an auto focus control unit (not shown in FIG. 1), and is configured to adjust the focus of the first image capturing device 110 and the second image capturing device 120. The pre-calibrated data record the relationships between the optimum rotation angles, focus distance, and focus information (e.g. digital-to-analog converter index), may be saved in a non-volatile memory such as an EEPROM.

It should be noted that the first rotation settings may indicate how the first image capturing device 110 can be rotated. Specifically, the first rotation settings may include the rotation angle to rotate the first image capturing device 110 on the plane of the first optical axis, and/or the rotation angle to rotate the first image capturing device 110 about the center of the first image capturing device 110. Similarly, the second rotation settings may indicate how the second image capturing device 120 can be rotated. Specifically, the second rotation settings may include the rotation angle to rotate the second image capturing device 120 on the plane of the second optical axis, and/or the rotation angle to rotate the second image capturing device 120 about the center of the second image capturing device 120.

In block 630, the first control unit 112 and the second control unit 122 rotates the first image capturing device 110 and the second image capturing device 120 according to the first rotation settings and the second rotation settings, respectively.

In block 640, the first control unit 112 and the second control unit 122 return a first finish rotating signal and a second finish rotating signal to a rotation synchronization control unit (e.g. processor 130) after the rotating is finished.

In block 650, the rotation synchronization control unit (e.g. processor 130) returns a finishing rotating signal to the application, so that the video recording application can be informed to start video recording. In addition, the rotation synchronization control unit may also return the finish rotating signal to the rotation control unit for enabling next rotation settings if necessary.

In the following sections, various methods for estimating rotation angles are described.

### Offline Calibration Stage in Pre-Calibration Phase

In the offline calibration stage, pre-calibrated data for each of the parallel mode, the divergence mode, and the convergence mode are trained.

Step 1: a chessboard chart, a dot chart, and the like can be built, and the first image capturing device 110 and the second image capturing device 120 are used to capture images of the chessboard chart, for example. Thus, an included angle between the first optical axis of the first image capturing device 110 and the second optical axis of the second image capturing device 120 can be calculated and recorded.

Step 2: a percentage of overlapping between the first FOV and the second FOV for each pattern are computed as a “scene overlapping score”.

Step 3: Step 1 and Step 2 are performed repeatedly to obtain a maximal or minimal score. The maximal or minimal score depends on the operational mode of the stereoscopic camera device 100. For example, in order to obtain a wide-angle image, the divergence mode should be used, and the scene overlapping score should be minimized. That is, the overlapping region between the first FOV and the second FOV may be reduced as much as possible for a widest-angle image or to different extents according to different requirements or designs.

Step 4: The estimated optimum angle, focus distance, and focus information (e.g. digital-to-analog converter index) are stored into a non-volatile storage such as an EEPROM or the like.

Step 5: Steps 1˜4 are performed repeatedly and the photographic distances are also changed accordingly to obtain optimum rotation angles for difference scene distances.

### Online Application Stage in Pre-Calibration Phase

In the online application stage, calibration information for each of the parallel mode, the divergence mode, and the convergence mode is obtained and delivered to the first image capturing device 110 and the second image capturing device 120.

Step 1: The associated calibration data are retrieved from the non-volatile storage as described in the offline calibration stage.

Step 2: Focus information are obtained from the retrieved calibration data.

Step 3: The rotation angles are obtained from the retrieved calibration data.

Step 4: The obtained rotation angles are provided to the first control unit 112 and the second control unit 122.

Step 5: After receiving the finishing rotating signal, the first image and the second image are processed to generate an output image. For example, in order to obtain a wide-angle image in the divergence mode, the processor 130 has to perform an image stitching algorithm to stitch multiple images (e.g. the first image and the second image) into one wide-angle image.

### Estimation Stage in Online Computation Phase

In the online application stage, image features of the first image and the second image are used to estimate the rotation angles for the first image image capturing device 110 and the second image capturing device 120 in each of the parallel mode, the divergence mode, and the convergence mode.

Step 1: The first image from the first image capturing device 110 and the second image from the second image capturing device 120 are obtained.

Step 2: Images features of the first image and the second image are calculated. For example, the image features may be colors of pixels, feature points, or any other feature capable of representing the images.

Step 3: The calculated image features of the first image and the second image are used to estimate the rotation angles for the first image capturing device 110 and the second image capturing device 120. For example, a feature extraction and matching algorithm are used to obtain a set of feature correspondences which can be used to compute the relative angles between first image capturing device 110 and the second image capturing device 120, and thus the rotation angles for the first image capturing device 110 and the second image capturing device 120 can be determined accordingly.

### Application Stage in Online Computation Phase

In the application stage, calibration information for each of the parallel mode, the divergence mode, and the convergence mode is obtained and delivered to the first image capturing device 110 and the second image capturing device 120.

Step 1: The determined rotation angles are provided to the first control unit 112 and the second control unit 122.

Step 2: After receiving the finishing rotating signal, the first image and the second image are processed to generate an output image. For example, in order to obtain a wide-angle image in the divergence mode, the processor 130 has to perform an image stitching algorithm to stitch multiple images (e.g. the first image and the second image) into one wide-angle image.

FIG. 7 is a flow chart of a control method for the stereoscopic camera device in accordance with an embodiment of the invention. In step S710, the first image capturing device is utilized to capture a first image with a first field of view along a first optical axis. In step S720, the second image capturing device is utilized to capture a second image with a second field of view along a second optical axis simultaneously with the first image capturing device, wherein the first field of view and the second field of view are overlapped. In step S730, the overlapping of the first field of view and the second field of view is dynamically adjusted according to an operational mode of the stereoscopic camera device.

The control method may include one or more operations, actions, or functions as represented by one or more steps such as steps S710-S730. Although illustrated as discrete steps, various steps of the method may be divided into additional steps, combined into fewer steps, or eliminated, depending on the desired implementation. The method may be implemented by the stereoscopic camera device 100 of FIG. 1 and the rotation control of FIG. 7 but is not limited thereto. Solely for illustrative purpose and without limiting the scope of the present disclosure, the control method of FIG. 7 is described below in the context of method 7 being performed by the stereoscopic camera device 100 of FIG. 1 with the rotation control of FIG. 6A. The method may begin at 610.

In view of the above, a stereoscopic camera device and an associated control method are provided with different embodiments. The stereoscopic camera device and the associated control method are capable of dynamically adjusting the overlapping region of the field of views of the cameras, which may be performed according to an operational mode of the stereoscopic camera device. In different operational modes, the optical axes of the first image capturing device 110 and the second image capturing device 120 may cross in front of the image capturing devices (e.g. the convergence mode), cross at the back of the image capturing devices (e.g. the divergence mode), or do not cross each other (e.g. the parallel mode). The overlapping region between the first FOV of the first image capturing device 110 and the second FOV of the second image capturing device 120 may also change according to the operational mode. In addition, the aspect ratio of the first image and the second can also be adjusted by rotating the first image capturing device 110 about the center of the first image capturing device 110 and rotating the second image capturing device 120 about the center of the second image capturing device 120, respectively. Accordingly, the first image and the second image can be merged to generate an output image for different applications such as an HDR image, an ultra wide-angle image, a panorama image, a sphere image, noise reduction, and macro photography.

While the invention has been described by way of example and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A stereoscopic camera device, comprising:
a first image capturing device, configured to capture a first image with a first field of view along a first optical axis;
a second image capturing device, configured to capture a second image with a second field of view along a second optical axis simultaneously with the first image capturing device, wherein the first field of view and the second field of view are overlapped;
a processor, configured to dynamically adjust the overlapping of the first field of view and the second field of view according to an operational mode of the stereoscopic camera device.

2. The stereoscopic camera device as claimed in claim 1, wherein in different operational modes of the stereoscopic device, the first optical axis of the first image capturing device and the second optical axis of the second image capturing device cross at different locations or do not cross at any location.

3. The stereoscopic camera device as claimed in claim 1, wherein the processor further merges the first image and second image to generate a third image covering a third field of view along a third optical axis.

4. The stereoscopic camera device as claimed in claim 1, wherein the processor dynamically adjusts the overlapping of the first field of view and the second field of view further according to one or more of an AF control signal, a synchronization control signal, image content of the first image, image content of the second image, and pre-calibrated data.

5. The stereoscopic camera device as claimed in claim 1, wherein the processor dynamically adjusts the overlapping of the first field of view and the second field of view by rotating at least one of the first image capturing device and the second image capturing device.

6. The stereoscopic camera device as claimed in claim 5, wherein the rotating of at least one of the first image capturing device and the second image capturing device comprises one or more of the following operations: rotating the first optical axis of the first image capturing device on a plane of the optical axis, rotating the first optical axis of the first image capturing device around an extension direction of the first optical axis, rotating the second optical axis of the second image capturing device on a plane of the optical axis, and rotating the second optical axis of the second image capturing device around an extension direction of the second optical axis.

7. The stereoscopic camera device as claimed in claim 3, wherein in the dynamically adjusting the overlapping of the first field of view and the second field of view, the third image has at least two different aspect ratios.

8. The stereoscopic camera device as claimed in claim 1, wherein when the stereoscopic camera device operates in a parallel mode, the first optical axis of the first image capturing device is parallel with the second optical axis of the second image capturing device.

9. The stereoscopic camera device as claimed in claim 8, wherein in the parallel mode, the processor further calculates depth information according to the first image and the second image.

10. The stereoscopic camera device as claimed in claim 1, wherein when the first camera and the second optical axis of the second camera cross in back of the first camera of the second camera.

11. The stereoscopic camera device as claimed in claim 10, wherein in the divergence mode, the processor further performs one or more of the following applications: obtaining an ultra wide-angle image, obtaining a panorama image and sphere shooting.

12. The stereoscopic camera device as claimed in claim 1, wherein when the stereoscopic camera device operates in a convergence mode, the first optical axis of the first camera and the second optical axis of the second camera cross in front of the first camera of the second camera.

13. The stereoscopic camera device as claimed in claim 12, wherein in the convergence mode, the processor further performs one or more of the following applications: obtaining a high dynamic range (HDR) image, noise reduction, and macro photography.

14. The stereoscopic camera device as claimed in claim 3, wherein in each of at least one mode of different modes of the stereoscopic camera, at least one of the first image capturing device and the second image capturing device is in a landscape mode or a portrait mode, such that the third image has different aspect ratios.

15. The stereoscopic camera device as claimed in claim 1, wherein the first image capturing device and the second image capturing device focus on different objects.

16. The stereoscopic camera device as claimed in claim 1, wherein the first image capturing device and the second image capturing device focus on the same one or more objects.

17. The stereoscopic camera device as claimed in claim 1, wherein the processor is further configured to:
compute image features of the captured first image and the captured second image, compute a relative angle between the first image capturing device and second image capturing device according to the image features, and determine a rotation angle for alternating the first optical axis of the first image capturing device and the second optical axis of the second image capturing device according to the relative angle.

18. A control method for a stereoscopic camera device, wherein the stereoscopic camera device comprises a first image capturing device and a second image capturing device, the method comprising:
utilizing the first image capturing device to capture a first image with a first field of view along a first optical axis;
utilizing the second image capturing device to capture a second image with a second field of view along a second optical axis simultaneously with the first image capturing device, wherein the first field of view and the second field of view are overlapped; and
dynamically adjusting the overlapping of the first field of view and the second field of view according to an operational mode of the stereoscopic camera device.

19. The control method as claimed in claim 18, wherein in different operational modes of the stereoscopic camera device, the first optical axis of the first image capturing device and the second optical axis of the second image capturing device cross at different locations or do not cross at any location.

20. The control method as claimed in claim 18, wherein the processor further merges the first image and second image to generate a third image covering a third field of view along a third optical axis.

21. The control method as claimed in claim 18, wherein the processor dynamically adjusts the overlapping of the first field of view and the second field of view by rotating at least one of the first image capturing device and the second image capturing device.

22. The control method as claimed in claim 21, wherein the rotating of at least one of the first image capturing device and the second image capturing device comprises one or more of the following operations: rotating the first optical axis of the first image capturing device on a plane of the optical axis, rotating the first optical axis of the first image capturing device around an extension direction of the first optical axis, rotating the second optical axis of the second image capturing device on a plane of the optical axis, and rotating the second optical axis of the second image capturing device around an extension direction of the second optical axis.

23. The control method as claimed in claim 20, wherein in the dynamically adjusting the overlapping of the first field of view and the second field of view, the third image has at least two different aspect ratios.

24. The control method as claimed in claim 18, further comprising:
computing image features of the captured first image and the captured second image;
computing a relative angle between the first image capturing device and second image capturing device according to the image features; and
determine a rotation angle for alternating the first optical axis of the first image capturing device and the second optical axis of the second image capturing device according to the relative angle.
